(19) United States
(12) Patent Application Publication
(10) Pub. No.: US 2022/0218014 A1
(43) Pub. Date: Jul. 14, 2022

(54) FROTH GENERATING DEVICE FOR PRODUCING A LIQUID FROTH AS WELL AS A FROTH DISPENSING DEVICE AND A BEVERAGE DISPENSING DEVICE

(71) Applicant: J.M. DE JONG DUKE AUTOMATENFABRIEK B.V., Sliedrecht (NL)

(72) Inventors: Andreas Jacobus Louis NIJSEN, Sliedrecht (NL); Jaap Jozua VAN BOXTEL, Sliedrecht (NL); Dennis Johannes WILLARD, Sliedrecht (NL); Maarten WASSINK, Sliedrecht (NL); Cornelis DE GROEN, Sliedrecht (NL)

(21) Appl. No.: 17/607,754

(22) PCT Filed: Apr. 29, 2020
(86) PCT No.: PCT/NL2020/050269

§ 371 Date: Oct. 29, 2021

(30) Foreign Application Priority Data
Apr. 30, 2019 (NL) 2023039
Oct. 11, 2019 (NL) 2023999

(51) Int. Cl. A23P 30/40; A47J 31/44

(52) U.S. Cl. CPC A23P 30/40; A47J 31/4485

(57) ABSTRACT

Device for producing a liquid froth from a liquid, particularly a milk-containing or at least milky liquid, comprising a frothing unit (300) with a frothing chamber (350) which is provided with a liquid inlet (310) and a froth outlet (320) which are spatially separated from each other. A rotor body (330) arranged for rotation about a rotation axis X is provided in the frothing chamber. The rotor body (330) leaves a gap (360) to a chamber wall (351, 352) of the frothing chamber clear all around. The liquid inlet (310) and the froth outlet (320) are connected via the gap. In the axial direction from the liquid inlet (310) to the froth outlet (320) the rotor body has externally a decreasing active section which particularly gradually narrows. The chamber wall (351, 352) and the rotor body (330) comprise at least substantially parallel active surfaces directed toward each other, at least one surface of which is accidented at least at the position of the gap (360). Such a froth producing device is particularly suitable for a froth dispensing device and/or a beverage dispensing device,

The present invention relates to a device for producing a liquid froth from a liquid, particularly a milk-containing or at least milky liquid, comprising a frothing unit with a frothing chamber which is provided with a liquid inlet and a froth outlet which are spatially separated from each other, wherein in the frothing chamber a rotor body is provided for rotation about a rotation axis, wherein the rotor body leaves a gap to a chamber wall of the chamber clear all around, and wherein the liquid inlet and the froth outlet are connected via the gap. It is noted here that, unless expressly stated otherwise or implicitly apparent, where reference is simply made to a wall in the present application, this must also be understood to mean an assembly of connected walls. The invention moreover relates to a froth dispensing device and to a beverage dispensing device in which such a froth producing device is applied. It is noted here that where reference is made in the present application to producing froth, this is also understood to mean stabilizing and/or modifying froth already partially produced from the liquid and supplied at the liquid inlet as fluid.

A froth producing device of the type described in the preamble can particularly be utilized for the so-called frothing of milk, at least a milk (protein)-containing liquid for adding to a coffee product. There are different techniques for producing a milk foam from milk. A known technique is for instance to introduce for instance steam into milk under pressure in turbulent manner and thus directly produce the final milk foam, as is also done manually by traditional, artisan coffee baristas. It is also known to produce milk foam mainly in mechanical manner by mechanically introducing air with an agitating member, such as a whisk or rotor. In practice, such a milk foam produced by whipping milk has been found to be particularly firm and stable.

A froth producing device which produces milk into a liquid milk foam in such a mechanical manner is for instance known from international patent application WO 2016/151,422 in the name of the Italian company Rancilio Group S.P.A. The device known therefrom comprises a frothing unit with a frothing chamber. The frothing chamber is provided with a liquid inlet for optionally heated liquid, such as heated milk, and downstream thereof with an outlet from which a produced froth can escape. Situated between the inlet and the outlet, in the frothing chamber, is a rotor which is set into rotation around a central axis of the frothing chamber by a motor provided for this purpose. A conical rotor body carried by the rotor here leaves clear a constant, narrow gap to a wall of the correspondingly formed frothing chamber.

This gap is the only flow path available to the liquid from the liquid inlet to the liquid outlet. The liquid is therefore urged into this flow path, and entrains air herein. This results in laminar flow behaviour of the liquid in the gap between two parallel surfaces rotating relative to each other, also referred to as Taylor-Couette flow. In the narrow gap the liquid is subjected to a viscosity-induced resistance (drag). At lower rotational speeds (i.e. numbers of revolutions) this flow is stable. When the rotational speed is however increased beyond the threshold value, the liquid flow becomes unstable and eventually turbulent, and air bubbles are formed and trapped. Finally, these air bubbles are manifested as such as a liquid froth which can be taken away at the outlet.

A milk foam deemed to be of good quality is firm, aerated and stable, which means that it maintains its volume for longer. The foam is preferably composed here of fine air bubbles rather than larger bubbles. The frothing power of the device is determined from an increase in volume of the foam relative to the quantity of starting liquid. The device is preferably furthermore relatively insensitive to the nature and temperature of the starting liquid used.

The present invention has for its object, among others, to provide a froth producing device whereby such a stable and aerated milk foam can be produced.

In order to achieve the stated object a froth producing device of the type described in the preamble has the feature according to the invention that in the axial direction from the liquid inlet to the froth outlet the rotor body has externally a decreasing active section, and particularly gradually narrows, and that the chamber wall and the rotor body comprise at least substantially parallel active surfaces directed toward each other, at least one surface of which is accidented at least at the position of the gap. What is important in this respect is that the rotor body according to the invention narrows toward the outlet. It is suspected that the decrease in rotational speed associated therewith stabilizes the froth before the froth is dispensed at the outlet.

The relief which is provided on one or both active main surfaces provides for additional agitation in the frothing liquid, which eventually becomes manifest in an increased yield in respect of froth production. A particular embodiment here has the feature according to the invention that the active surface of the outer wall narrows at least substantially gradually, particularly conically, in axial direction and that the gap from the liquid inlet to the froth outlet has over at least a part of a length thereof an at least substantially fixed gap width.

In respect of a gap width of the gap formed between the active surface of the rotor body and the chamber wall of the chamber, a balance between flow resistance on the one hand and an effective froth production of the liquid on the other is a particular aim. In practice it has been found that an optimal balance, particularly for hot froth, is achieved in a further particular embodiment of the froth producing device according to the invention, which is characterized in that the gap width is smaller than about 1 mm, particularly lies between 0.1 and 0.6 mm, and more particularly lies between 0.3 and 0.6 mm.

According to the invention, at least one of the two active main surfaces is accidented. This can involve a more or less random relief, but also an optionally more or less regular pattern of irregularities, particularly in the form of elevations, depressions or a combination of elevations and depressions.

In a first preferred embodiment the froth producing device has the feature according to the invention that the irregularities are at least substantially mutually congruent and are provided in a regular pattern. The surface in question particularly comprises here a pattern of pits, more particularly round pits, also referred to as dimples, bulges, grooves or ribs. The density and individual shape and size can be varied here for further optimizing the quality of the intended froth.

A further particular embodiment of the froth producing device according to the invention is characterized in that the irregularities are elongate, with a longitudinal direction extending at a fixed angle relative to a transverse plane through the rotation axis of the rotor body. A further embodiment thereof has the feature here that successive irregularities are always directed counter to a rotation direction of the rotor body. Such a surface of elongate depressions (pits) and/or elevations (bulges) carries the liquid alternately along the longitudinal direction defined thereby and therebetween along a radial direction imposed by the rotation. This agitation of the liquid results in a finely distributed air bubble formation and, eventually, a firm, aerated and voluminous froth from the liquid, particularly from animal or plant-based milk.

With a view to an axial transport of the liquid to the froth outlet a further particular embodiment of the device has the feature here that successive irregularities are mutually offset in axial direction and are particularly provided at least substantially along a helical line of a number of imaginary, mutually parallel helical lines. Successive irregularities thus carry the liquid along a helix to the outlet, whereby a certain pump action is obtained, this enhancing the dispensing of froth at the outlet.

This is further enhanced by a further particular embodiment of the device which is characterized in that the at least one accidented active surface comprises a pattern of depressions which each narrow toward the froth outlet. The narrowing of the depressions results here in a smaller enclosed volume, so that the liquid will be forced therefrom. This self-discharging action further enhances the axial liquid transport of the liquid and/or the froth produced therefrom toward the outlet.

In a second preferred embodiment the froth producing device according to the invention is characterized in that one of the active surfaces comprises a number of ribs, each running helically along a helical line of a number of imaginary, mutually parallel helical lines, and more particularly in that the helical lines define a pitch which is directed in a rotation direction of the rotor body. When the rotor rotates, such a pattern of helical ribs results in a corresponding turbulence in the liquid, wherein air bubbles are formed and become trapped therein in particularly effective manner. In addition, such a multiple helix provides a particularly powerful forward propulsion of the liquid/froth mixture to the froth outlet, which enhances the liquid transport and the froth discharge.

Comparative research research has shown that, among a number of configurations compared to each other therein, a preferred embodiment of the device was always characterized in that the rotor body at least comprises the at least one accidented surface. If the rotor body takes a removable form here, this furthermore simplifies possible cleaning, replacement and/or maintenance thereof.

The device is suitable for both producing cold froth and producing hot froth, wherein the liquid is in the latter case preheated or heated in the chamber. With a view to this latter, a first particular embodiment of the froth producing device has the feature according to the invention that the frothing chamber comprises close to the liquid inlet a steam inlet for letting in hot steam, while a second particular embodiment is here characterized in that a heating device is provided upstream of the liquid inlet for the purpose of heating the liquid. A further particular embodiment of the froth producing device here has the feature according to the invention that the heating device comprises a steam generator for generating hot steam and introducing it into the liquid.

For the purpose of producing cold or at least unheated froth outstanding results have been achieved with a preferred embodiment of the device according to the invention, characterized in that both the outer wall of the rotor body and the chamber wall of the frothing chamber comprise an accidented surface. For the purpose of producing both cold or at least unheated and hot or at least heated froth use is preferably made here of a further preferred embodiment of the froth producing device of the invention, characterized in that the outer wall of the active surface of the rotor body comprises one of a regular pattern of depressions and a number of helical ribs with a pitch in the rotation direction, wherein the chamber wall comprises an active surface with a regular pattern of depressions.

The present invention also relates to a froth dispensing device provided with a froth producing device according to the invention as described above. According to the invention, such a froth dispensing device comprises a housing with, in addition to such a froth producing device,
a liquid reservoir for holding the liquid, particularly a milk-containing or at least milky liquid;
pump means with a liquid conduit for carrying the liquid from the liquid reservoir to an inlet of the frothing unit, which inlet is coupled to the liquid inlet of the frothing chamber;
switchable heating means upstream of the liquid inlet in heat-exchanging contact with the liquid in the liquid conduit for the purpose of optionally heating the liquid; and
a froth outlet coupled to the froth outlet of the frothing chamber, at which a froth produced from the liquid can be received.

The invention provides hereby an autonomous device for producing liquid froth from a starting liquid, particularly from a plant-based or animal milk. With a view to extending the storage life of animal milk products in particular, a preferred embodiment of the froth dispensing device here has the feature according to the invention that cooling means are provided in heat-exchanging contact with the liquid reservoir.

For the purpose of application with hot beverages use is preferably made of a likewise hot froth in order to thus influence a temperature of the hot beverage to at least a lesser degree thereby. With a view hereto, a particular embodiment of the froth dispensing device has the feature according to the invention that the heating means comprise a mixing device downstream of the pump means, with a mixing chamber which is provided with a first inlet to which the liquid conduit is coupled, a second inlet to which a steam conduit is coupled and with an outlet which is coupled to the inlet of the frothing unit.

The invention also relates to a beverage dispensing device provided with a froth producing device according to the invention as described above. According to the invention, such a beverage dispensing device comprises such a froth producing device and a decoction device for preparing a hot beverage from water and a powder, particularly from hot water and ground coffee,
wherein a liquid reservoir is provided for the purpose of holding a liquid for frothing, particularly a milk-containing or at least milky liquid, which liquid reservoir is coupled by a liquid conduit to the liquid inlet of the frothing chamber of the froth producing device;
wherein the decoction device comprises a water inlet to which a water conduit is coupled for the purpose of supplying a quantity of water;
wherein the decoction device comprises a product outlet at which a watery mixture or extract of the powder escapes during operation;
wherein the froth outlet of the frothing chamber of the froth producing device is coupled to a froth dispenser;
wherein the product outflow of the decoction device is coupled to a product dispenser in the vicinity of the froth dispenser;
wherein the froth producing device and the decoction device are coupled to a shared water supply; and
wherein the housing comprises control means which are able and configured to control a water and powder supply to the decoction device for the purpose of setting into action and controlling the decoction device and setting into action and controlling the froth producing device.

This involves particularly what is usually referred to as a coffee machine, wherein the liquid reservoir is intended and configured to keep animal or plant-based milk or at least a milky liquid, which is suitable for producing milk foam, cooled and wherein the powder comprises coffee bean grounds. The milk foam to be produced thereby in combination with a coffee extract is particularly suitable for preparation of coffee-milk foam variations such as cappuccino and latte. A particular embodiment of the beverage dispensing device is here characterized in that cooling means are provided in heat-exchanging contact with the liquid reservoir. The cooling here increases the storage life of the milk product.

The invention will be further elucidated hereinbelow with reference to an exemplary embodiment and an accompanying drawing. In the drawing:

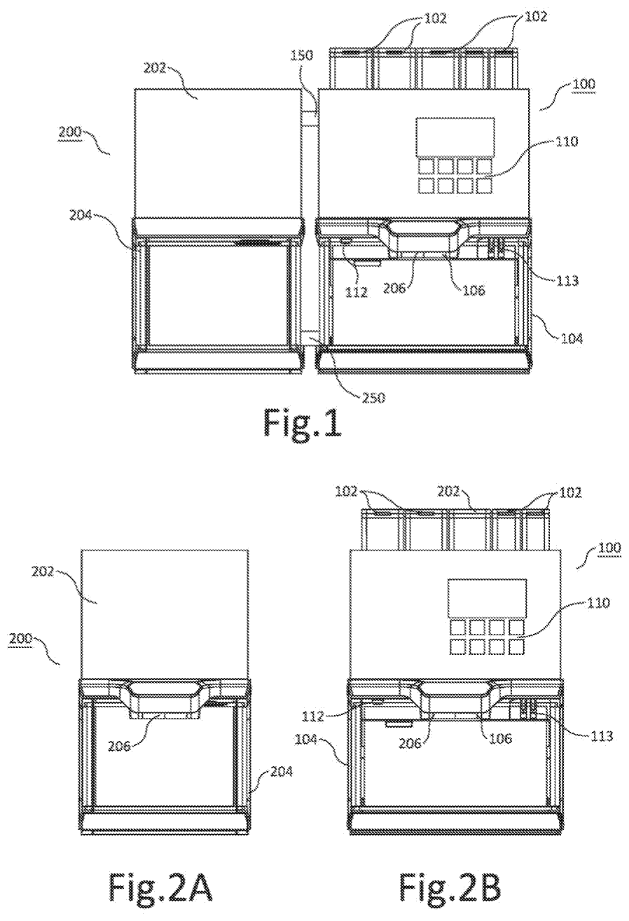

FIG. 1 shows an exemplary embodiment of a beverage dispensing device in combination with a froth dispensing device according to the invention;

FIG. 2A shows an exemplary embodiment of a froth dispensing device according to the invention;

FIG. 2B shows an exemplary embodiment of a beverage dispensing device according to the invention;

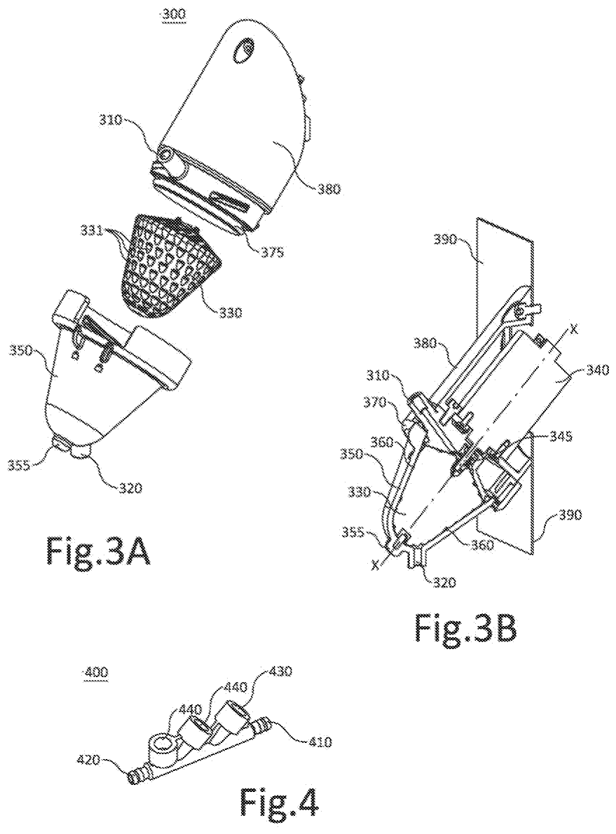

FIG. 3A shows an exploded view of a frothing unit as applied in the froth producing device of each of the devices of FIGS. 1, 2A and 2B;

FIG. 3B shows a cross-section of the frothing unit of FIG. 3A;

FIG. 4 shows a perspective view of a steam injector for application with the frothing unit of FIGS. 3A and 3B;

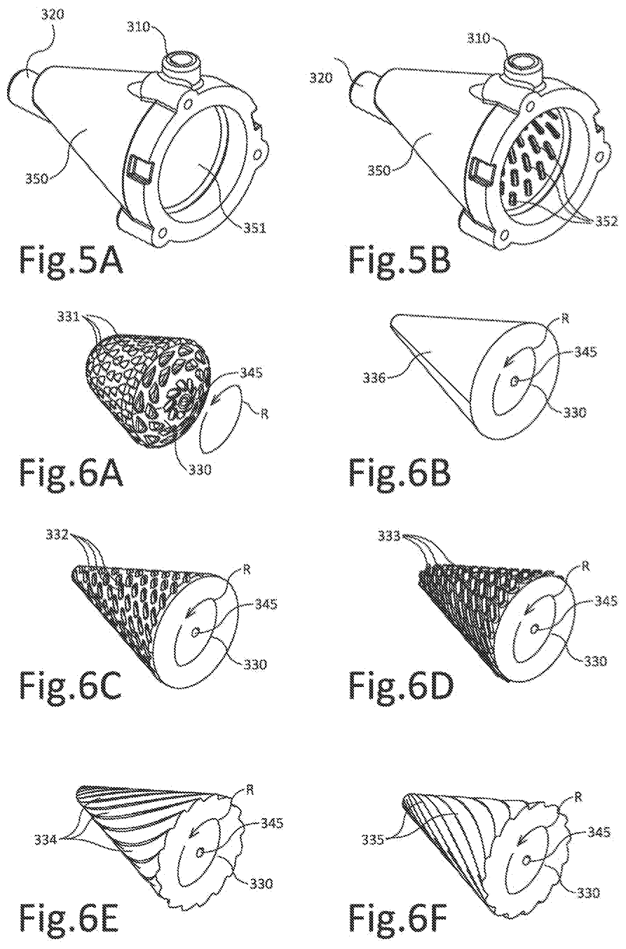

FIG. 5A shows a perspective view of a first embodiment of a frothing chamber of a froth producing device according to the invention;

FIG. 5B shows a perspective view of a second embodiment of a frothing chamber of a froth producing device according to the invention;

FIG. 6A-6F show different embodiments of a rotor body as can be applied with the frothing chambers of FIGS. 5A and 5B;

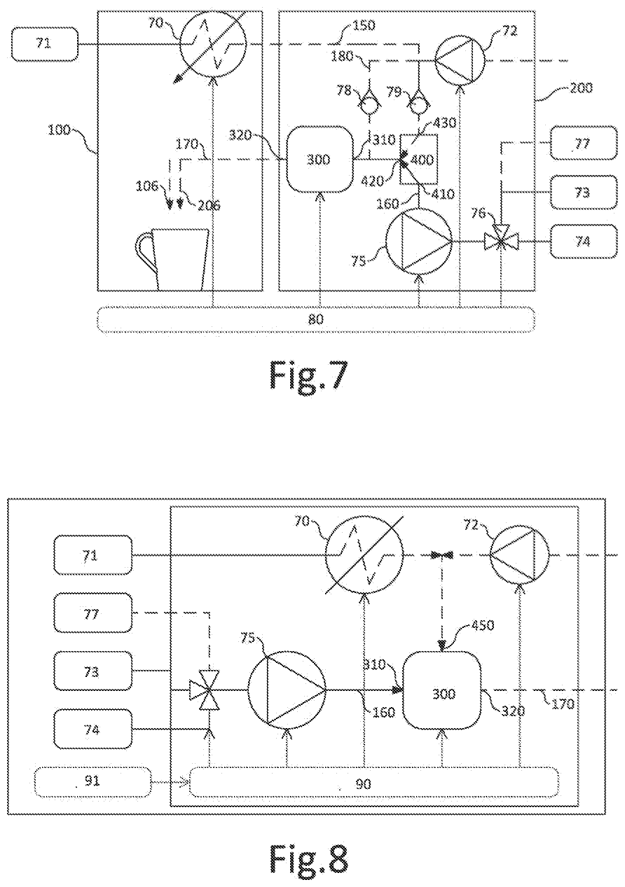

FIG. 7 shows an electromechanical operating diagram of the device of FIG. 1; and

FIG. 8 shows an electromechanical operating diagram of the device of FIG. 2B.

It is otherwise noted here that the figures are purely schematic and not always drawn to (the same) scale. Some dimensions in particular may be exaggerated to greater or lesser extent for the sake of clarity. Corresponding parts are designated in the figures with the same reference numeral.

FIG. 1 shows a setup of a device 100 for preparing a hot beverage, with adjacently thereof or at least close thereto a device 200 for producing a liquid froth which can be used in combination with that beverage. This involves particularly a more or less traditional coffee/espresso machine 100 with one or more bean reservoirs 102 for coffee beans, which open onto a grinding unit (not further shown) in the housing 104 of the machine. Although not further shown, but deemed sufficiently known to a person with ordinary skill in the art, the housing further provides space for a hot water appliance such as a boiler or thermal block, a control unit and a pump with which hot water is carried to a decoction group under increased pressure.

The decoction group comprises here a decoction chamber in which ground coffee powder is received from the grinding unit and is compressed so as to then extract a coffee extract therefrom under increased pressure with a dosed quantity of hot water. This extract is receivable at a double dispenser 106. This can be espresso coffee of a desired strength or another coffee product, such as lungo or americano, depending on a preference of the user, which he or she can enter via a user interface 110 provided for this purpose. The housing also accommodates a steam generator and a steam dispenser 112 at which hot steam can be taken away. A set of further dispensers 113 for dispensing hot and cold water is also provided.

The decoction group can otherwise optionally also be fed with ground coffee powder which was received directly from a reservoir or inlet in question, in which case a bean grinder can optionally be dispensed with in the device. Use can also be made of a soluble product, such as freeze-dried coffee, in which case the decoction device will comprise not much more than a mixing chamber in which the product is mixed with a dosed quantity of hot water and dissolved therein.

Placed near the coffee machine is a stand-alone device 200 with which a milk foam can be produced from cold milk for the purpose of preparing for instance cappuccino or latte in combination with the coffee product obtained from coffee machine 100. The device comprises for this purpose a cooled milk reservoir 202 with a suitable animal or plant-based milk product. By means of a pump provided for this purpose in a housing 204 of frothing device 200 milk is carried from reservoir 202 to a liquid inlet of a frothing unit, which is shown further in FIGS. 3A and 3B.

Upstream of the liquid inlet the liquid runs through a steam or air injector 400, see FIG. 4, which is received in the milk conduit for this purpose. This comprises an ingoing connection 410 and an outgoing connection 420 in line with the milk conduit, in addition to a set of inlets 430 for steam and an outlet 440 for ambient air. In order to prevent an air/steam/liquid mixture from escaping from injector 400 non-return valves are arranged in or close to otherwise open inlets 430, 440.

Steam inlets 430 can be fed by an own steam generator in the housing 204 of frothing device 200. It is however also possible to obtain hot steam from coffee machine 100 via a steam conduit 150 provided for this purpose and corresponding connections which are then provided between the two devices 100, 200. Inversely, the steam generator of frothing device 200 can also serve coffee machine 100 via a steam conduit 150 provided for this purpose. Injector 400 produces an air/milk or steam/milk mixture with which frothing unit 300 is fed and from which a liquid milk foam is produced by a frothing unit, which foam is carried via a conduit 250 provided for this purpose to the main device 100 and can therein be taken away at a second dispenser 206. The operation of the frothing unit will be described below in more detail.

The frothing device according to the invention can also be applied in stand-alone manner. FIG. 2A shows an example hereof. The device is largely identical to the device 200 which is placed near device 100 for preparing a hot beverage in FIG. 1, albeit that in a stand-alone embodiment the conduits 150, 250 are absent or are at least not connected, and device 200 itself is equipped with a froth dispenser 206. Upstream, froth dispenser 206 is coupled to an outlet of a milk frothing unit which is received in device 200.

Instead of taking the form of two individual devices, the assembly of FIG. 1 can also be integrated into a single device, as shown in FIG. 2B. In this case the device comprises besides a functional part for preparing a coffee product, as described above, optionally also a functional part for preparing milk foam. Besides one or more bean reservoirs 102, a cooled milk reservoir 202 is for this purpose also provided in the device, and the device also comprises a dispenser 206 for milk foam in the double coffee dispenser 106.

As shown further in an exploded view in FIG. 3A, and in cross-section in FIG. 3B, milk frothing unit 300 comprises a frothing chamber 350 which is provided with a liquid inlet 310 and a froth outlet 320. An entrance of liquid inlet 310 is here coupled to the outlet 420 of steam injector 400, while froth outlet 320 is coupled to the froth dispenser 206 of the device. A rotor body 330 is rotatable inside frothing chamber 350 about an axially directed rotation axis X driven by an electric motor 340, an output drive shaft 345 of which protrudes into rotor body 330. Output drive shaft 345 protrudes here through an opening in a cover 370 which closes the frothing chamber 350, wherein both a bearing and a liquid barrier are provided in the opening. Rotor body 330 is also bearing-mounted and fixated at a distal outer end. Frothing chamber 350 comprises for this purpose a press-fit base bearing 355. Electric motor 340 is accommodated in a motor housing 380 which is in turn connected to the frame 390 of the device.

As is shown particularly clearly in FIG. 3B, liquid inlet 310 and froth outlet 320 are connected to each other by a narrow gap 360 between rotor body 330 and the chamber wall of frothing chamber 350. Optionally heated milk which is let in via liquid inlet 310 can only reach the froth outlet via the gap 360. The rapidly rotating rotor body here agitates the liquid, whereby it mixes with air and air bubbles form therein. The thus produced milk foam exits the frothing chamber via the froth outlet. It is important here within the scope of the present invention that a section of rotor body 330, and likewise a section of frothing chamber 350, decreases in axial direction. Due to this (here) gradual narrowing of the rotor body, the peripheral speed decreases at a given number of revolutions, whereby the produced froth will stabilise further. The number of revolutions of the rotor body is typically in the order of magnitude of 2000-5000 revolutions per minute, with a diameter of the rotor body running (narrowing) from wide to narrow in axial direction over a length of the channel 360.

Within the scope of the present invention it is also important that at least one of the outer surface of the rotor body and the surface of the chamber wall is not flat but accidented at the position of channel 360. This can take various forms. In the example of FIGS. 3A and 3B the surface of the rotor body is as such provided with a large number of substantially congruent dimples 331 which are arranged over a periphery thereof in successive rows, see also FIG. 6A. The dimples 331 of axially successive rows are here offset relative to each other and thereby lie at least substantially on an imaginary helical line of a number of mutually parallel helical lines. As shown in FIG. 3A, dimples 331 each narrow toward outlet 320, i.e. in downstream direction. Due to this gradually smaller volume of dimples 331, the liquid will be gradually forced therefrom. This makes dimples 331 self-discharging.

Use can be made of a frothing chamber 350 with a completely flat, smooth inner wall 351, at least at the position of rotor body 330, as shown in FIG. 5A, but this inner wall can also be provided with irregularities 352, as shown in FIG. 5B. When it comes to these irregularities use is then in respect of the chamber wall preferably made of depressions 352 with regard to adequate cleaning of the system, wherein this system must be rid of any possible milk residues. In the case of such an accidented chamber wall 350 use can if desired be made of a smooth rotor body 330, for instance as shown in FIG. 6B, with a smooth peripheral wall 336.

FIGS. 6C-6F show non-limitative further examples of rotor body 330 as it can be embodied within the scope of the invention. FIGS. 6C and 6D involve here respectively elongate depressions 332 and elevations 333 which are provided in a regular pattern. The relevant irregularities 332, 333 are here oriented with their major axis along an imaginary helix of a number of mutually parallel helices which can be imagined over the surface of the rotor body. A pitch of the helix in question is directed opposite to a rotation direction R of rotor body 330 and thereby also an orientation of the relevant irregularities.

Further alternative embodiments of rotor body 330 are shown in FIGS. 6E and 6F, wherein the surface of rotor body 330 is accidented in that a set of parallel ribs 334, 335 or grooves extends thereover. These ribs/grooves 334, 335 here run along an imaginary helical line of a number of parallel helical lines with a pitch that rotates along with the rotation direction R of rotor body 330, i.e. is directed in this rotation direction.

The gap 360 between rotor body 330 and the chamber wall typically has a width of less than a millimetre. For the purpose of producing cold milk foam the specific width has been found not to be very critical here. A good froth yield can be obtained in the whole area below a gap width of 1 millimetre. In some cases the stability of the froth does decrease significantly starting at a gap width above about 0.6 millimetres. Use is therefore preferably made of a gap width below this size of 0.6 millimetres. In that case the froth is found not to have collapsed, or hardly so, even after 5 minutes.

For producing hot froth a gap width of below 0.8 millimetres, particularly between 0.3 and 0.6 millimetres, has been found preferable in any case. Within this whole range the frothing device produces an acceptable froth yield in terms of volume increase, wherein with a gap width of between 0.3 and 0.6 millimetres the froth also retains its form for a sufficient period of time. Both froth yield and stability are always found to increase as the gap width decreases. On the other hand, a (through)flow resistance of the device will likewise increase as the gap width decreases, and the yield per unit of time will hereby also decrease. In addition, a good throughflow is also important when the device is subjected to being flushed for the purpose of cleaning the components. With a view to said yield, throughflow and, above all, tolerance a gap width above 0.1 millimetre is therefore preferably maintained. In the exemplary embodiments provided here use is made of a gap width of about 0.3 to 0.6 millimetres as preference and happy medium.

FIGS. 7 and 8 shows schematically a concise technical operating diagram of the device of respectively FIGS. 1 and 2. FIG. 7 represents here a stand-alone froth dispensing device 200 adjacently of or at least near a beverage dispensing device 100 as shown in FIG. 1. Beverage dispensing device 100 comprises a steam generator 70 with a water supply 71 for the purpose of own steam dispenser 112, see also FIG. 1. Via a steam conduit 150 provided for this purpose between the two devices 100, 200 this steam generator 70 is also utilized for the froth dispensing device 200 and is here coupled to a steam inlet 430 of a steam injector 400. Froth dispensing device 200 can optionally also be applied in stand-alone manner, in which case such a or a similar steam provision 70 will be accommodated in the froth dispensing device 200 itself.

Froth dispensing device 200 comprises one or more reservoirs 73, 74 in which a liquid for frothing can be held. This example involves two milk containers for animal or plant-based milk, wherein the two reservoirs can be deployed to be able to hold a double quantity of the same liquid together or each individually contain a different milk product, for instance respectively animal cow's milk and plant-based soy or almond milk. A selection can be made from the two products by means of a three-way valve 76 applied for this purpose in a downstream liquid conduit. A reservoir 77 for holding a cleaning liquid is additionally coupled to the three-way valve, from which reservoir the device can be flushed periodically or on demand with a cleaning liquid held therein. For the purpose of extending the storage life of the milk products in the first two stated reservoirs 73, 74 they are embodied with a thermally insulating casing and provided with a forced and preferably thermostatically controlled cooling.

Reservoirs 73, 74, 77 are coupled to a pump 75 whereby, depending on the position of the three-way valve 76, a liquid is drawn therefrom and is pumped under pressure to an inlet 410 of steam injector 400 which is arranged in milk conduit 160. In the steam injector a milk/steam mixture is formed and the liquid is heated under the influence of the hot steam to a temperature of typically between 55° C. and 65° C. This mixture exits the steam injector at the outlet 420 thereof. A set of non-return valves 78, 79 prevents this mixture from being able to enter steam conduit 150 or air conduit 180. As is the case here, it is then still possible upstream for air to be blown into the mixture downstream thereof using an air pump 72 which is provided for this purpose and draws in air from the surrounding area. The thus formed steam/air mixture is carried to an inlet 310 of frothing unit 300 wherein the mixture is produced by means of agitation, as described above, into a firm and aerated milk foam which can be taken away at a froth outlet 320.

The produced froth can be carried via a froth conduit 170 between the two devices to a froth dispenser 206 which is placed in the vicinity of a coffee dispenser 106 of coffee machine 100 so as to receive a coffee with milk foam product thereunder. Alternatively, froth dispenser 206 can also be provided in froth dispensing device 200, as shown in FIG. 1. In that case the user has to move a cup or mug from the one device to the other in order to receive both products. For operation, control and monitoring of the froth dispensing device a processor-controlled control unit 80 is provided in device 200, which unit is also operatively coupled to at least the steam generator 70 in the coffee machine 100 if, as in the shown situation, use is made thereof. Control unit 80 is further operatively coupled to inter aria the two pumps 72, 75, the three-way valve 76 and the frothing unit 300, as shown with respective broken lines in the figure.

Instead of two separate devices, as in FIG. 1, use can also be made of a fully integrated application, wherein both a decoction device for preparing a hot beverage and a froth producing device, among other things, are accommodated in a collective housing. Such a device is shown in FIG. 2, and FIG. 8 provides a possible operating diagram therefor with several components specifically involved therein. Components corresponding to those of the device of FIG. 7 here have the same reference numeral and substantially the same operation, albeit that in this case a separate steam injector 400 is not applied, but steam and air are let directly into the frothing chamber via inlets or a shared inlet 450 of the frothing chamber then provided for this purpose. In this case the operation and monitoring of the froth producing device is also controlled by a processor-controlled control unit 90 which is provided for this purpose and is here coupled to or forms part of the control unit 91 of the coffee preparing part of the device, which is not further discussed here and is assumed sufficiently well known. The produced milk foam exits the frothing chamber via a froth conduit 170.

Although the invention has been further elucidated above with reference to only a single exemplary embodiment, it will be apparent that the invention is by no means limited thereto. On the contrary, many variations and embodiments are still possible within the scope of the invention for a person with ordinary skill in the art.

1. Device for producing a liquid froth from a liquid, particularly a milk-containing or at least milky liquid, comprising a frothing unit with a frothing chamber which is provided with a liquid inlet and a froth outlet which are spatially separated from each other, wherein in the frothing chamber a rotor body is provided for rotation about a rotation axis, wherein the rotor body leaves a gap to a chamber wall of the frothing chamber clear all around, and wherein the liquid inlet and the froth outlet are connected via the gap, wherein in the axial direction from the liquid inlet to the froth outlet the rotor body has externally a decreasing active section, and particularly gradually narrows, and wherein the chamber wall and the rotor body comprise at least substantially parallel active surfaces directed toward each other, at least one surface of which is accidented at least at the position of the gap.

2. Froth producing device according to claim 1, wherein the active surface of the outer wall narrows at least substantially gradually, particularly conically, in axial direction and wherein the gap from the liquid inlet to the froth outlet has over at least a part of a length thereof an at least substantially fixed gap width.

3. Froth producing device according to claim 1, wherein the gap width is smaller than about 1 mm, particularly lies between 0.1 and 0.6 mm, and more particularly lies between 0.3 and 0.6 mm.

4. Froth producing device according to claim 1, wherein the at least one accidented surface comprises an optionally regular pattern of irregularities.

5. Froth producing device according to claim 4, wherein the irregularities are at least substantially mutually congruent and are provided in a regular pattern.

6. Froth producing device according to claim 4, wherein the irregularities are elongate, with a longitudinal direction extending at a fixed angle relative to a transverse plane through the rotation axis of the rotor body.

7. Froth producing device according to claim 6, wherein successive irregularities are always directed counter to a rotation direction of the rotor body.

8. Froth producing device according to claim 1, wherein the at least one accidented active surface comprises a pattern of depressions which each narrow toward the froth outlet.

9. Froth producing device according to claim 4, wherein successive irregularities are mutually offset in axial direction and are particularly provided at least substantially along a helical line of a number of imaginary, mutually parallel helical lines.

10. Froth producing device according to claim 1, wherein one of the active surfaces comprises a number of ribs, each running helically along a helical line of a number of imaginary, mutually parallel helical lines.

11. Froth producing device according to claims 9, wherein the helical lines define a pitch which is directed in a rotation direction of the rotor body.

12. Froth producing device according to claim 1, wherein the rotor body at least comprises the at least one accidented surface.

13. Froth producing device according to claim 1, wherein both the outer wall of the rotor body and the chamber wall of the frothing chamber comprise an accidented surface.

14. Froth producing device according to claim 13, wherein the outer wall of the active surface of the rotor body comprises one of a regular pattern of depressions and a number of helical ribs with a pitch in the rotation direction, wherein the chamber wall comprises an active surface with a regular pattern of depressions.

15. Froth producing device according to claim 1, wherein a motor is provided for the purpose of rotating the rotation body about the rotation axis.

16. Froth producing device according to claim 1, wherein the frothing chamber comprises dose to the liquid inlet a steam inlet for letting in hot steam.

17. Froth producing device according to claim 1, wherein a heating device is provided upstream of the liquid inlet for the purpose of heating the liquid.

18. Froth producing device according to claim 17, wherein the heating device comprises a steam generator for generating hot steam and introducing it into the liquid.

19. Froth dispensing device, comprising a housing with:
a froth producing device according to claim 1;
a liquid reservoir for holding the liquid, particularly a milk-containing or at least milky liquid;
pump means with a liquid conduit for carrying the liquid from the liquid reservoir to an inlet of the frothing unit, which inlet is coupled to the liquid inlet of the frothing chamber;
switchable heating means upstream of the liquid inlet in heat-exchanging contact with the liquid in the liquid conduit for the purpose of optionally heating the liquid; and
a froth outlet coupled to the froth outlet of the frothing chamber, at which a froth produced from the liquid can be received.

20. Froth dispensing device according to claim 19, wherein cooling means are provided in heat-exchanging contact with the liquid reservoir.

21. Froth dispensing device according to claim 19, wherein the heating means comprise a mixing device downstream of the pump means, with a mixing chamber which is provided with a first inlet to which the liquid conduit is coupled, a second inlet to which a steam conduit is coupled and with an outlet which is coupled to the inlet of the frothing unit.

22. Beverage dispensing device, comprising a froth producing device according to claim 1, and a decoction device for preparing a hot beverage from water and a powder, particularly from hot water and ground coffee,
wherein a liquid reservoir is provided for the purpose of holding a liquid for frothing, particularly a milk-containing or at least milky liquid, which liquid reservoir is coupled by a liquid conduit to the liquid inlet of the frothing chamber of the froth producing device;
wherein the decoction device comprises a water inlet to which a water conduit is coupled for the purpose of supplying a quantity of water;
wherein the decoction device comprises a product outlet at which a watery mixture or extract of the powder escapes during operation;
wherein the froth outlet of the frothing chamber of the froth producing device is coupled to a froth dispenser;
wherein the product outflow of the decoction device is coupled to a product dispenser in the vicinity of the froth dispenser;
wherein the froth producing device and the decoction device are coupled to a shared water supply; and
wherein the housing comprises control means which are able and configured to control a water and powder supply to the decoction device for the purpose of setting into action and controlling the decoction device and setting into action and controlling the froth producing device.

23. Beverage dispensing device according to claim 22, wherein cooling means are provided in heat-exchanging contact with the liquid reservoir.
